(19) United States
(12) Patent Application Publication
(10) Pub. No.: US 2024/0389825 A1
(43) Pub. Date: Nov. 28, 2024

(54) MOP HOLDER FOR A MOP SYSTEM, MOP SYSTEM, MOP HANDLE FOR A MOP SYSTEM, AND USE OF THE MOP SYSTEM

(71) Applicant: Hydroflex Group GmbH, Buseck (DE)

(72) Inventors: Edward Becker, Fernwald (DE); Terry Becker, Gladenbach (DE); Peter Nober, Rommersheim (DE); Maximilian Morgenstern, Mainz (DE)

(21) Appl. No.: 18/693,903

(22) PCT Filed: Sep. 21, 2022
(86) PCT No.: PCT/EP2022/076250

§ 371 Date: Mar. 20, 2024

(30) Foreign Application Priority Data
Sep. 21, 2021 (DE) 10 2021 124 414.5

(51) Int. Cl. A47L 13/258; B25G 1/04; B25G 1/10; B25G 3/20

(52) U.S. Cl. CPC A47L 13/258; B25G 1/04; B25G 1/10; B25G 3/20

(57) ABSTRACT

A mop holder for a mop system for cleaning clean rooms, arranged and adapted to releasably hold a mop cover, wherein the mop holder comprises an aramid fiber-reinforced and/or carbon fiber-reinforced plastic. In at least one embodiment, the mop holder comprises at least one holding wing that has a longitudinal rib which is curved towards an upper side of the mop holder, and the longitudinal rib extends from a flat section to the upper side.

### BACKGROUND

### Technical Field

The present disclosure relates to a mop holder and a mop system comprising a mop holder and a mop handle. The present disclosure further comprises a mop handle for a mop system. According to the disclosure, a use of the mop system is provided, for example, for cleaning floors, walls and/or ceilings in particular in preferably sterile clean rooms.

### Description of the Related Art

Mop systems are used for cleaning floors or other surfaces in clean rooms. Working in clean rooms is accompanied by particular hygiene requirements. This relates to the working equipment and methods that can be used, for example, in clean rooms. It is of primary importance to prevent the introduction of contaminants, such as particles and/or germs, into the clean room, as well as any cross-contamination of clean objects by contaminants of other objects.

For mop systems and other objects that are introduced into clean rooms, it is generally the case that these must be decontaminatable and disinfectable or even sterilizable, for example by autoclaving at 121° C. for up to 25 minutes or at 134° C. for up to 6 minutes. The mop systems must likewise be resistant to cleaning agents, disinfecting agents and/or solvents. Disinfecting agents comprise, for example, diamines, isopropanol, ethanol, active chlorine, and hydrogen peroxide. Cleaning agents comprise, for example, alkaline cleaning agents, such as sodium hydroxide, and/or acidic cleaning agents. A solvent is, for example, acetone. For cleaning rooms in semiconductor manufacturing, an exclusion of metal constituents in the working equipment also applies.

In the cleaning of clean rooms, it is of particular importance to make all necessary working steps as reproducible as possible. In this case, the correct use of the mop system by the cleaning personnel is of great importance.

In the case of conventional cleaning systems with mop system, the cleaning personnel often has to make considerable efforts for various working steps. This applies particularly in the cleaning of wall and/or ceiling surfaces, during which the cleaning personnel is burdened by the weight of the mop system, and to an increased extent for cleaning personnel of small body size. Experience has shown that excessive physical burden on the cleaning personnel leads quickly to fatigue and demotivation.

It has further been found that, when working in clean rooms, the number of individual manual working steps should be kept as small as possible. In cleanrooms, few individual work steps are advantageous, as particles are released into the cleanroom with every movement by the cleaning personnel and the work equipment. Such a release of particles should be minimized as far as possible.

A cleaning device for clean rooms in the form of a mop system, which comprises a shaft section, a closure element and a holder for a mop cover, is described for example in DE 20 2013 011 946 Ul.

### BRIEF SUMMARY AND INITIAL DESCRIPTION

The present disclosure provides a device, a kit of parts, and a method of use, which can be used particularly easily, in particular with as few individual handling movements as possible, and/or with the application of as little force as possible by cleaning personnel.

The present disclosure relates to a mop holder, in some cases a flat mop holder, for a mop system for cleaning clean rooms, wherein the mop holder is arranged and adapted to hold a mop cover, preferably a flat mop cover, and in some cases releasably hold the mop cover.

According to the present disclosure, the mop holder comprises aramid fiber-reinforced and/or carbon fiber-reinforced plastic or consists of aramid fiber-reinforced and/or carbon fiber-reinforced plastic. The mop holder is generally arranged and adapted to be fastenable or fastened to a (lower) end of a mop handle. When cleaning a wall or a ceiling of a clean room, the mop holder therefore brings about a lever effect by its weight, which the cleaning personnel has to compensate. The mop holder expediently has a weight of at most 450 g, in some cases at most 300 g, preferably at most 200 g or at most 150 g. In some cases, the mop holder comprises at least 50%, at least at least 60%, or at least 80% or at least 95% fiber-reinforced plastic (FRP and/or CFP), preferably at least 90% fiber-reinforced plastic (FRP and/or CFP), particularly preferably at least 95% fiber-reinforced plastic. The proportion of the aramid fiber-reinforced and/or carbon fiber-reinforced plastic is determined in some cases in relation to the surface of the mop holder, preferably the surface of the side of the mop holder to be directed toward the floor. It should be clear that the proportion of fiber-reinforced plastic of the mop holder does not take into account a connecting piece realized in some cases by an articulated connection for connecting the mop holder and the mop handle to one another. By the mop holder being formed in a weight-saving manner with aramid fiber-reinforced and/or carbon fiber-reinforced plastic material, a particularly effective work facilitation for the cleaning personnel can be provided. The mop holder can comprise a plurality of mop holder parts, in some cases mop holding wings, movable relative to one another. The mop holding wings can be transversely foldable along a pivot axis in the mop width direction or longitudinally foldable along a pivot axis in the mop longitudinal direction. In some cases, the carbon fiber-reinforced plastic comprises carbon nanotubes. Conventional mop holders, for example made of stainless steel or aluminum, can experience plastic deformations in the case of severe loading, for example as a result of loading with the body weight of the cleaning personnel during use on a concave surface, which deformations subsequently impair the cleaning effect. In contrast, mop holders made of aramid fiber-reinforced and/or carbon fiber-reinforced plastic have a particular dimensional stability.

According to at least one embodiment, the mop holder has a rectangular basic shape. In some cases, the mop holder has a length in the range of 35 to 55 cm, in some cases in the range of 40 cm to 50 cm, preferably 40 cm to 50 cm, and a width in the range of 8 or 10 cm to 20 cm, in some cases in the range of 12 to 17 cm. The mop holder can be used in some cases in combination with the mop handle described below.

According to at least one embodiment, the mop holder can be realized as a flat mop holder having a first mop holding wing and a second mop holding wing. Preferably, the mop holding wings each have a wing upper side and a wing lower side. The mop holding wings have two mutually opposite transverse edges and two mutually opposite longitudinal edges, wherein in each case one outer longitudinal edge faces away from the other mop holding wing. The mop holding wings can in some cases have inner longitudinal edges which face toward one another. The longitudinal edges of a mop holding wing are longer than the transverse edges thereof. Preferably, the longitudinal extent of the longitudinal edges of the mop holder is greater than the transverse width of the mop holder. The transverse width of the mop holder can be defined by the cumulative transverse width of the transverse edge of the first mop holding wing and the transverse edge of the second mop holding wing. Preferably, the mop holder and/or the mop holding wings have a substantially rectangular basic shape. The longitudinal extent of the flat mop holder can correspond to the respective longitudinal extent of the first and/or of the second mop holding wing. The longitudinal extent of the mop holder can be in the range from 40 to 55 cm, in some cases in the range from 45 to 50 cm, preferably at approximately 48 cm. Additionally or alternatively, the width of the mop holder can be in the range from 10 to 20 cm, in some cases in the range from 12 to 17 cm, preferably at approximately 14.5 cm. At least one of the two mop holding wings is movable relative to the other mop holding wing. Preferably, the second mop holding wing can be pivotable relative to the first mop holding wing and a connecting piece fastened or fastenable to the first mop holding wing. It can be preferred that one of the mop holding wings, in some cases the second mop holding wing, is pivotable relative to the other mop holding wing about a longitudinal axis of the flat mop holder.

Alternatively or additionally, in an embodiment of the mop holder as a flat mop holder, at least one of the holding wings, in some cases both of the holding wings, can have a longitudinal rib which is curved, in some cases convexly towards the upper side. In some cases, the at least one longitudinal rib extends from a flat section to the upper side. Flat sections of the holding wing can be provided on both sides in the transverse direction relative to the at least one longitudinal rib. The longitudinal rib can extend in the longitudinal direction along the entire longitudinal extent of the respective mop holding wing. By providing one or more ribs, an increased rigidity of the flat mop holder can be brought about, and therefore a more precise positioning of the flat mop cover for an improved cleaning effect.

The present disclosure also relates to a mop system comprising a mop holder, a mop handle and optionally a connecting part, in some cases an articulated connection. In some cases, the mop system comprises aramid fiber-reinforced and/or carbon fiber-reinforced plastic or consists of aramid fiber-reinforced and/or carbon fiber-reinforced plastic. In some cases, the mop system comprises aramid fiber-reinforced and/or carbon fiber-reinforced plastic or consists thereof. In some cases, the carbon fiber-reinforced plastic comprises carbon nanotubes. The mop system can comprise the mop handle described below, the mop holder described above and/or the connecting part described below. The mop system generally has a total length or telescopic length which is composed of the length of the mop holder, of the connecting part, of the mop handle or the mop handle sections thereof and optionally of an end piece, such as a handle.

The mop system can be telescopic. The mop system comprises at least one retracted configuration in which the mop system is retracted to a minimum mop handle telescopic length. The minimum telescopic length is in some cases in the range 100 cm to 190 cm, preferably in the range 120 cm to 160 cm, particularly preferably in the range 130 to 140 cm. The mop system comprises at least one extended configuration in which the mop system is extended to a maximum telescopic length. The maximum telescopic length is in some cases in the range 140 cm to 250 cm, preferably in the range 180 cm to 220 cm, particularly preferably in the range 205 cm to 215 cm.

According to a preferred embodiment, the mop system is heat-resistant to 140°. Alternatively or additionally, the mop system is resistant to cleaning and/or disinfecting agents and/or solvents. The mop system can in some cases be adapted and arranged to be resistant to active substances permitted in clean rooms and/or common active substances for surface disinfection. In some cases, cleaning and/or disinfecting agents and/or solvents can be selected from a group consisting of surfactants, acids, bases, bleaching agents, enzymes, alcoholic solutions and mixtures thereof.

According to the present disclosure, the use of the above-described mop system is provided for cleaning floors, walls and/or ceilings, in some cases in preferably sterile clean rooms.

According to another aspect of the present disclosure, which can be combined with one or more of the above, a mop handle for a mop system is provided in some cases for cleaning clean rooms consisting of or comprising aramid fiber-reinforced and/or carbon fiber-reinforced plastic. It can be preferred that the mop handle comprises aramid fiber-reinforced and/or carbon fiber-reinforced plastic. A mop handle can be formed at least in sections with or from aramid fiber-reinforced and/or carbon fiber-reinforced plastic. It is conceivable that a mop handle has one or more aramid fiber-reinforced and/or carbon fiber-reinforced plastic layers. Alternatively, it can be preferred that the mop handle consists of aramid fiber-reinforced and/or carbon fiber-reinforced plastic. The mop handle has a length of at least 100 cm, preferably in the range of 120 to 240 cm, in some cases in the range of 160 to 220 cm, preferably in the range of 180 to 200 cm. The mop handle expediently has a weight of at most 800 g, in some cases at most 600 g, preferably at most 500 g or at most 400 g. In some cases, the mop handle comprises at least 50%, at least 60%, or at least 80% aramid fiber-reinforced and/or carbon fiber-reinforced plastic, preferably at least 90%, particularly preferably at least 95% aramid fiber-reinforced and/or carbon fiber-reinforced plastic, in some cases in relation to the area of the surface of the mop handle or the length of the mop handle in the longitudinal axis direction thereof. The mop handle, which can also be referred to as a shaft, makes up a large part of the weight of a conventional mop system. By using an aramid fiber-reinforced and/or carbon fiber-reinforced plastic instead of the common stainless steel or thick-walled plastic variants, a considerable weight reduction can be achieved. The use of a mop handle consisting of or comprising aramid fiber-reinforced and/or carbon fiber-reinforced plastic allows the use of the mop system in some cases for cleaning walls and/or ceilings for longer periods of time with lower physical burden. Surprisingly, it has been found that aramid fiber-reinforced and/or carbon fiber-reinforced plastic has material properties which allow use for cleaning clean rooms.

According to at least one embodiment, the mop holder or the mop system comprises a plastic material, in some cases selected from a group consisting of thermosets, preferably epoxy resins, thermoplastics and mixtures thereof. Thermoplastics can preferably be selected from a group consisting of polyamides (PA), polyolefins, preferably polypropylene (PP), polyetherimides (PEI), polysulfones (PSU), polyetheretherketone (PEEK), polyacetals, preferably polyoxymethylene (POM), polyvinylidene fluoride (PVDF), polyphenylene sulfone (PPSU), polyethersulfone (PES), polyamide imide (PAI), polybenzimidazole (PBI) and mixtures thereof. The mop system can comprise various plastic materials. For example, a fiber-reinforced, in some cases aramid fiber-reinforced and/or carbon fiber-reinforced, mop holder or mop handle section can comprise a first plastic material, in some cases as matrix material. The mop system can comprise a different, second, third and/or further plastic material. In some cases, a handle of the mop system can comprise or consist of, in some cases, a second plastic material. In some cases, a connecting piece of the mop system can comprise or consist of, in some cases, a third plastic material. In some cases, an at least one locking device of the mop system can comprise or consist of, in some cases, a fourth plastic material. The plastic material of the connecting piece, of the at least one locking device and/or of the handle is in some cases a thermoplastic, preferably selected from a group consisting of polyamides, polyolefins, preferably polypropylene, polyetherimides, polysulfones, polyetheretherketone, polyacetals, preferably polyoxymethylene, polyvinylidene fluoride, polyphenylene sulfone, polyethersulfone, polyamide imide, polybenzimidazole and mixtures thereof. The plastic material of the connecting piece, of the at least one locking device and/or of the handle can particularly preferably be POM, POM-GF (glass fiber-reinforced POM), PA-GF (glass fiber-reinforced PA), PP mineral-reinforced (in some cases talcum-reinforced), PEI, PSU or PEEK.

According to at least one embodiment, the mop handle comprises at least one tubular mop handle section. A mop handle section can also be referred to as a shaft partial section. The mop handle section expediently has a weight of at most 400 g, in some cases at most 300 g, preferably at most 200 g or at most 150 g. The tubular mop handle section can comprise or consist of aramid fiber-reinforced and/or carbon fiber-reinforced plastic. A mop handle section can be formed at least in sections with or from aramid fiber-reinforced and/or carbon fiber-reinforced plastic. It is conceivable that a mop handle section has one or more aramid fiber-reinforced and/or carbon fiber-reinforced plastic layers. In some cases, the tubular mop handle section has a wall thickness in the range of 0.01 mm to 3 mm. The tubular mop handle section preferably has a wall thickness of at most 1 mm, in some cases at most 0.5 mm, preferably less than 0.3 mm. The wall thickness of the tubular mop handle section can be at least 0.05 mm or at least 0.1 mm.

In a further development, the mop handle section can have a rounded, in some cases circular, oval or polygonal, cross-sectional shape. A rounded polygonal cross-sectional shape can be, for example, hexagonal or octagonal with rounded corners. The mop handle section can have an at least in sections oval cross-section. The rounded cross-sectional shape makes the mop handle decontaminatable and ergonomic. It should be clear that a mop handle or mop handle section can have a constant cross-sectional shape. Alternatively, it is conceivable that a mop handle or mop handle section can have different longitudinal sections with different cross-sectional shapes. In the case of a mop handle or mop handle section with longitudinal sections of different cross-sectional shapes, it can be preferred that the different cross-sectional shapes merge into one another continuously and/or rounded.

According to a preferred embodiment, the mop handle comprises a plurality of mop handle sections movable telescopically relative to one another. In some cases, the mop handle can have exactly two mop handle sections movable telescopically relative to one another. Alternatively, the mop handle can have three, four or more mop handle sections which are movable telescopically relative to one another. The mop handle comprises at least one retracted configuration in which the mop handle is retracted to a minimum mop handle telescopic length. The minimum mop handle telescopic length is in some cases in the range 120 cm±25 cm, preferably in the range 121±10 cm. The mop handle comprises at least one extended configuration in which the mop handle is extended to a maximum mop handle telescopic length. The maximum mop handle telescopic length is in some cases in the range 180 cm±25 cm, preferably in the range 181±10 cm. The extension width, i.e., the cumulative width of the length adjustability of the mop handle, is in some cases in the range 50 cm to 100 cm, preferably in the range 60 cm to 80 cm, particularly preferably 70 cm.

According to a preferred embodiment of a mop handle with exactly two or more mop handle sections, the mop handle comprises at least one inner mop handle section and at least one outer mop handle section which receives the at least one inner mop handle section at least in sections. It should be clear that the terms “inner” and “outer” denote the relation of two directly adjacent mop handle sections relative to one another. In some cases, a subset of the inner mop handle section is received in the interior of a corresponding subset of the outer mop handle section. For example, the mop handle can be composed of two mop handle sections, a first, inner, preferably lower, mop handle section and a second, outer, preferably upper, mop handle section. In a combination of this embodiment with the above-described embodiment with at least one locking device, the at least one locking device is preferably arranged on the (second) outer mop handle section, preferably fastened. It should be clear that the term “bottom” is used synonymously to mop holder near and the term “top” is used synonymously to mop holder far. Preferably, an outer mop handle section has a length in the range 950 cm±25 cm, in some cases in the range 950 cm±10 cm. Preferably, the outer mop handle section is tubular. Preferably, an inner mop handle section has a length in the range of 100 cm±25 cm, in some cases in the range 101 cm±10 cm. Preferably, the inner mop handle section is tubular. An inner, tubular mop handle section can receive a structural reinforcement. The structural reinforcement can be formed for example by a foam, such as a metal foam or a polymer foam, wherein in some cases the foam predominantly, i.e., at least 50%, in some cases at least 75%, preferably at least 90%, or completely fills the tubular inner mop handle section.

It can be preferred that the at least one locking device is arranged, preferably fastened, on an operationally upper mop handle section and/or on an outer mop handle section. Operationally, the one locking device can be arranged on the mop handle in such a way that it is arranged at a distance from the ground surface in a range of 10 cm to 120 cm, preferably in a range of 20 cm to 100 cm, in the case of a mop holder with a mop cover resting on a ground surface. Preferably, in the retracted configuration, the distance of the one in some cases first locking device from the ground surface can be in the range 25 cm±10 cm. Preferably, in the extended configuration, the distance of the first locking device from the ground surface can be in the range 95 cm±10 cm.

In a further development of a mop handle, the at least one locking device comprises at least one support section fastened to the outer mop handle section in the longitudinal direction. In some cases, at least one pretensioning mechanism, such as a compression spring, is supported on the support section, wherein the pretensioning mechanism forces the holding member against the inner mop handle section. The pretensioning mechanism can be, for example, at least one compression spring which is oriented in the longitudinal direction of the mop handle, in some cases coaxially to the longitudinal direction of the mop handle. The compression spring can radially surround the inner mop handle section. The pretensioning mechanism, in some cases the compression spring, can be arranged adjacent to the outer mop handle section in the longitudinal direction. Alternatively or additionally, at least one counter-stop is fastened to the support section, which has at least in sections an inclined, in some cases conical, wedge surface on which the holding member is guided in the radial direction and/or longitudinal direction. The counter-stop can be annular or cylindrical-sleeve-shaped. The counter-stop can have one or more wedge surfaces for one or more holding members. The wedge surface of the counter-stop preferably has an extent in the longitudinal direction and a tapering in the radial direction along the longitudinal direction extent. Preferably, the pretensioning mechanism forces the holding member in the longitudinal direction against the wedge surface. The counter-stop can be adapted and arranged to form an abutment radially opposite the inner mop handle section with respect to the holding member. For example, the holding member can be annular section-shaped, in some cases half-ring-shaped, and surround the inner mop handle section on the outer circumference. The holding member itself can be surrounded on the outer circumference by the counter-stop. The wedge surface of the counter-stop can have a tapering contour so that, when sliding along the wedge surface in the longitudinal direction, the holding member is forced radially in the direction towards the inner mop handle section. A sliding movement of the holding member relative to the wedge surface can be caused by the pretensioning mechanism, in some cases the compression spring.

According to another further development, which can be combined with the above, the at least one locking device comprises an at least one actuating part which is movable relative to the outer mop handle section and/or relative to the inner mop handle section. The actuating part is preferably movable rotationally with respect to the mop handle, in some cases in the circumferential direction of the mop handle. Alternatively, the at least one actuating part is movable translationally. The actuating part can be realized, for example, as an actuating ring or as an actuating sleeve. The actuating part is adapted and arranged to displace the holding member between the holding position and the release position. It can be preferred that the actuating part can assume a start position and a stop position. For example, the actuating part can be rotated in the circumferential direction with respect to the mop handle from the start position into the stop position and vice versa.

Preferably, the actuating part is adapted and arranged to displace the holding member after a rotation in a first direction of rotation in the circumferential direction with respect to the mop handle into the release position (start position). In some cases, the actuating part is adapted and arranged to allow the holding member to adopt the holding position (stop position) after a rotation in a second direction of rotation opposite to the first direction of rotation in the circumferential direction with respect to the mop handle. It preferred that the actuating part is movable relative to the mop handle in a different direction with respect to the telescopic or longitudinal direction, preferably the radial direction and/or the circumferential direction. Preferably, the actuating part is stationary relative to the outer mop handle section in the longitudinal direction. By the actuating direction of the actuating part differing from the direction of telescopic movement of the mop handle, incorrect operation of the mop handle can be avoided. By incorrect operation, an unintentional change in length and/or particle abrasion could occur.

Alternatively, in some cases, the first and/or second actuating part is adapted and arranged to displace the holding member into the release position (start position) after a translational displacement in a first direction of rotation with respect to the mop handle. In some cases, the first and/or second actuating part is adapted and arranged to allow the holding member to adopt the holding position (stop position) after a translational movement opposite to the first translational movement with respect to the mop handle.

In a particular embodiment, it can be provided that a first actuating part is preferably directly connected to the holding member, and that a second actuating part is connected to the first actuating part. Preferably, the second actuating part is adapted and arranged to cause the first actuating part to at least one displacement into the stop position and/or into the start position. The first actuating part and the second actuating part are preferably coupled to each other by way of, in some cases, a length-adjustable force transmission mechanism, such as a cable pull. Preferably, the first actuating part is fastened to the lower end and the second actuating part is fastened to the upper end of the outer mop handle.

In a preferred further development, the locking device comprises at least one sliding wedge, which is held stationary relative to the outer mop handle in the circumferential direction and movable in the radial direction. The sliding wedge can be held, for example, in a recess of the counter-stop or a multifunctional sleeve. The sliding wedge is guided on an, in some cases, eccentric inner contour of the actuating part such that in a first relative position of the actuating part to the sliding wedge (start position) the sliding wedge forces the holding member, in some cases against the pretensioning mechanism, into the release position. The sliding wedge is further guided on the eccentric inner contour of the actuating part such that in a second relative position of the actuating part to the sliding wedge (stop position) the pretensioning mechanism brings the holding member into the holding position. In some cases, the pretensioning mechanism presses the sliding wedge against the inner contour.

According to a preferred further development of the mop system with holding member(s), the at least one holding member has at least one gripping coating, which is arranged on an inner surface of the holding member facing the at least one mop handle section. The gripping coating can expediently be adapted for an adhesive pairing with the, in some cases inner, mop handle section. In some cases, the gripping coating and the, in some cases inner, mop handle section cooperating with the gripping coating are matched to one another such that the adhesive friction of the adhesive pairing is substantially, in some cases at least 3 times, preferably at least 5 times or at least 10 times, greater than the sliding friction. In some cases, the gripping coating comprises or consists of an elastomer material, in some cases a thermoplastic elastomer, preferably a TPU (thermoplastic elastomer) and/or TPV (thermoplastic vulcanizate). The gripping coating is accordingly preferably elastic or rubber-elastic, respectively. Preferably, the gripping coating comprises or consists of a thermoplastic elastomer (TPE) material. Suitable TPE materials can be selected from the group consisting of thermoplastic elastomers based on olefin (TPO), thermoplastic polyamide elastomers (TPA), thermoplastic copolyester elastomers (TPC), thermoplastic styrene block copolymers (e.g., SBS, SEBS, SEPS, SEEPS and MBS), thermoplastic elastomers based on urethane (TPU) and thermoplastic vulcanizates or crosslinked thermoplastic elastomers based on olefin (TPV). Particularly preferably, thermoplastic elastomers based on urethane (TPU) or thermoplastic vulcanizates or crosslinked thermoplastic elastomers based on olefin (TPV) are used. In some cases with the latter, preferably with thermoplastic elastomers based on urethane (TPU), particularly long-lived products are obtained, which retain their functionality in relation to the force-fitting connection without restriction even after a plurality of autoclaving cycles. The gripping coating can be fastened, for example injection molded, to a support body of the holding member. The support body can be manufactured from or comprise or consist of a thermosetting or a thermoplastic material, such as PEEK, PEI, POM and/or PPSU. If a thermoplastic material is used for the support body, gripping coating and support body can preferably also be obtained by way of 2K injection molding. In a holding member comprising a support body and a gripping coating, the gripping coating is preferably firmly connected to the support body. In some cases, the holding member has a support body. The support body is preferably fastened, in some cases injection molded, to the gripping coating; for example, the holding member can be manufactured as a 2- or more-component injection molded part. Preferably, the support body cooperates with the sliding wedge and/or the pretensioning mechanism, wherein the support body can be in touch contact with the sliding wedge and/or the pretensioning mechanism. Preferably, the support body forms the wedge surface. The holding member is preferably partially annular, in some cases substantially semi-annular. Preferably, the holding member does not extend fully circularly around the handle. Preferably, the gripping coating and/or, in some cases and, the support body are semi-annular. The support body can extend in the circumferential direction by at least 90°, in some cases at least 135°, preferably at least 160°, and/or less than 360°, in some cases less than 180°. Particularly preferably, the gripping coating extends in the circumferential direction by less than 360°, in some cases less than 180°, and/or optionally by at least 90°, in some cases at least 135°, preferably at least 160°. Preferably, the locking device is designed such that in some cases only the gripping coating is or can be brought into touch contact with the inner mop handle section. A locking mechanism designed in this way is particularly ergonomically operable and long-lived. By way of the gripping coating, it is possible to change between the release position and the holding position in a simple and reliable manner. In some cases, the holding member can be realized with the gripping coating in a particularly heat- and water-resistant manner, preferably autoclave-resistant.

According to another aspect of the present disclosure, a mop handle for a mop system, in some cases for cleaning preferably sterile clean rooms, can be provided, which can be combined with the above-mentioned embodiments and further developments. The mop handle comprises at least one inner mop handle section and at least one outer mop handle section which receives the at least one inner mop handle section at least in sections. The mop handle further comprises a locking device which has at least one, in some cases wedge-shaped, holding member which is movable transversely, in some cases radially, to the mop handle sections. The mop handle can comprise two, three, four or more holding members. The holding member is adapted and arranged to hold, in a holding position, at least one inner mop handle section in the longitudinal direction in a force-fitted in a fixed position relative to the at least one outer mop handle section. The holding member is further adapted and arranged to allow, in a release position, a translational movement of the inner mop handle section relative to the outer mop handle section in the longitudinal direction. The locking device comprises an actuating part, such as an actuating ring or an actuating sleeve, movable relative to the outer mop handle section, in some cases rotationally, preferably in the circumferential direction of the mop handle. The actuating part is adapted and arranged to displace the holding member between the holding position and/or release position.

According to a further development, the inner mop handle section has a different cross-sectional shape than the outer mop handle section. In some cases, the inner mop handle section can have a circular or oval cross-sectional shape. The outer mop handle section can in some cases have an oval or polygonal, preferably hexagonal or octagonal, cross-sectional shape. In some cases, the polygonal cross-sectional shape has rounded corners. Surprisingly, it has been found that through the use of different cross-sectional shapes, of which at least one, in some cases that of the outer mop handle section, is rotationally asymmetric, it is possible to realize in a particularly simple manner an anti-twist protection which is suitable in some cases for fiber-reinforced mop handles and/or mop handle sections. For anti-twist protection of the inner mop handle section in relation to the outer mop handle section, the inner mop handle section can be equipped, in some cases at its inner end, with a twist lock which is adapted in shape to the, in some cases rotationally asymmetric, preferably polygonal, inner contour of the outer mop handle section. The twist lock can be formed integrally with the inner mop handle section and/or connected to the inner mop handle section in a rotationally fixed manner. Alternatively or additionally, the twist lock is mounted within the outer mop handle section in a rotationally rigid and translationally movable manner relative to the longitudinal axis thereof.

According to a further development, the mop handle comprises a locking device which has at least one, in some cases wedge-shaped, holding member which is movable transversely, in some cases radially, to the mop handle sections. In a holding position, the holding member holds at least one mop handle section in the longitudinal direction in a fixed position relative to at least one other mop handle section. In a release position, the holding member permits a translational movement of the at least one mop handle section relative to the at least one other mop handle section. Preferably, the holding member can be spring-pretensioned in the direction of the holding position. A mop handle having more than two mop handle sections which are telescopic relative to one another can have a corresponding number of more than one locking device. Preferably, in the holding position, the holding member brings about a force-fitted connection between a first, in some cases inner, mop handle section and a second, in some cases outer, mop handle section. Preferably, a force-fitted connection is realized with respect to an inner mop handle section having a circular cross-section. The positional fixed position of the inner mop handle section relative to the outer mop handle section is stationary in some cases in the longitudinal direction, and optionally in the circumferential direction. In some cases, in the release position, a force-fitted connection with respect to the longitudinal direction between the inner and the outer mop handle is released. It is conceivable that, in the release position (and also in the holding position), a movability of the inner mop handle with respect to the outer mop handle in the circumferential direction is prevented, for example by a twist lock, such as a component extending radially through the inner and the outer mop handle section, or a rotationally asymmetric, preferably shape-complementary, shape configuration of the inner and/or outer mop handle, for example in the form of a polygonal cross-sectional shape. With respect to mop handle sections which comprise or consist of aramid fiber-reinforced and/or carbon fiber-reinforced plastic, a force-fitted locking device has proven to be particularly favorable.

According to at least one embodiment, the locking device comprises at least one support section fastened to the outer mop handle section in the longitudinal direction. At least one pretensioning mechanism, such as a compression spring, is supported on the support section, which forces the holding member against the inner mop handle section and/or on which at least one counter-stop is fastened. The counter-stop has an at least in sections inclined, in some cases conical, wedge surface on which the holding member is guided in the radial direction and/or longitudinal direction.

According to a further development, the locking device comprises a sliding wedge, which is held stationary relative to the outer mop handle in the circumferential direction and movable in the radial direction and which is guided on an, in some cases eccentric, inner contour of the actuating part such that in a first relative position of the actuating part to the sliding wedge the sliding wedge forces the holding member, in some cases against the pretensioning mechanism, into the release position, and that in a second relative position of the actuating part to the sliding wedge the pretensioning mechanism brings the holding member into the holding position, wherein in some cases the pretensioning mechanism presses the sliding wedge against the inner contour.

The mop handle with locking device and the components of the locking device can have the features described above, wherein the embodiment of the mop handle or the mop handle sections or the locking mechanism can be realized optionally, as described above, with an aramid fiber-reinforced and/or carbon fiber-reinforced plastic or without.

The present disclosure further optionally relates to a connecting part, in some cases an articulated connection, for preferably releasably connecting a mop holder to a mop handle, wherein the connecting part can comprise or consist of aramid fiber-reinforced and/or carbon fiber-reinforced plastic. In some cases, the connecting part comprises or consists of aramid fiber-reinforced and/or carbon fiber-reinforced plastic. The connecting part can be used in some cases in combination with the mop holder and/or mop handle described above.

The connecting part is generally arranged and adapted to be fastenable or fastened to a (lower) end of a mop handle, and arranged and adapted to connect the mop handle to a mop holder. When cleaning a wall or a ceiling of a clean room, the connecting part brings about a lever effect by its weight, which the cleaning personnel has to compensate. The connecting part expediently has a weight of at most 450 g, in some cases at most 300 g, preferably at most 200 g or at most 150 g. By the connecting part being formed in a weight-saving manner with aramid fiber-reinforced and/or carbon fiber-reinforced plastic material, a particularly effective work facilitation for the cleaning personnel can be provided. In some cases, the carbon fiber-reinforced plastic comprises carbon nanotubes.

The present disclosure further relates to a kit of parts comprising a mop holder described above, in some cases a flat mop holder, and a mop handle which can be realized as described above. The kit of parts can further comprise at least one flat mop cover, in some cases a plurality of flat mop covers. Preferably, the flat mop cover has a length in the range of 35 to 55 cm, in some cases in the range of 40 cm to 50 cm, preferably 40 cm to 50 cm, and a width in the range of 8 or 10 cm to 20 cm, in some cases in the range of 12 to 17 cm. The flat mop cover can in some cases have two or more pockets lying opposite in the longitudinal or transverse direction for receiving the flat mop holder at least in sections. Preferably, the flat mop cover comprises a microfiber material. In some cases, the kit of parts further comprises a connecting part which can in some cases be realized as described above. Additionally, the kit of parts can comprise a mop handle connected or connectable to the mop holder. The kit of parts can comprise a mop system as described above.

In a preferred embodiment, the connecting piece and/or the locking device and/or a handle comprises a thermoplastic material or consists of a thermoplastic material. The thermoplastic material can preferably comprise or be a polyacetal, particularly preferably polyoxymethylene (POM).

The aramid fiber-reinforced and/or carbon fiber-reinforced plastic comprises or consists of a matrix material and a fiber material. The matrix material comprises or consists of thermosets and/or thermoplastics, in some cases epoxy resins, polyester resins, vinyl ester resins or mixtures thereof. The fiber material comprises or consists of aramid fibers and/or carbon fibers, in some cases carbon nanotubes. The aramid fiber-reinforced and/or carbon fiber-reinforced plastic can have a density in the range from 1.5 to 1.6 g/cm³, in some cases in the range from 1.53 to 1.58 g/cm³, preferably about 1.55 g/cm³. The mop handle, the mop holder, the connecting piece and/or other components of the mop system can each be manufactured, for example, by hand lamination, in some cases in combination with vacuum pressing, autoclave methods, injection methods, in some cases resin transfer molding or reaction injection molding, winding methods or pressing methods, in some cases hot pressing methods, wet pressing methods or prepreg methods. In some cases, the mop handle, the mop holder, the connecting piece and/or another component of the mop system, which comprises or consists of aramid fiber-reinforced and/or carbon fiber-reinforced plastic, can have a wall thickness in the range from 0.01 mm to 3 mm, preferably a wall thickness of at most 1 mm, further preferably at most 0.5 mm, particularly preferably less than 0.3 mm. In some cases, the aramid fiber-reinforced plastic comprises at least 50% aramid fiber, preferably between 60% and 80% aramid fiber, particularly preferably about 70% aramid fiber. In some cases, the carbon fiber-reinforced plastic comprises at least 50% carbon fiber, preferably between 60% and 80% carbon fiber, particularly preferably about 70% carbon fiber. In addition, the fiber-reinforced plastic comprises not more than 50% matrix material, preferably between 20% and 40% matrix material, particularly preferably about 30% matrix material. The proportions can relate to % by weight. It can be preferred that the fiber-reinforced plastic has a twill fabric, in some cases a 2x2 twill fabric, such as a 3k twill 2x2. The fiber material can preferably have a fiber diameter of not more than 0.5 mm, preferably not more than 0.3 mm, particularly preferably a fiber diameter of 0.2 mm, and/or a fiber diameter of at least 0.1 mm. The fiber-reinforced plastic material, in some cases the aramid fiber-reinforced and/or carbon fiber-reinforced plastic material, can be formed in some cases from a prepreg material in the form of (carbon) fiber plates or a (carbon) fiber tube. The prepreg material can have unidirectional fiber layers. The prepreg material can comprise prepreg fabric layers. In some cases, a prepreg material layer has a thickness of at least 0.03 mm, preferably at least 0.075 mm, and/or not more than 0.3 mm, preferably not more than 0.2 mm or not more than 0.15 mm. The (carbon) fiber material is formed from at least one prepreg material layer, in some cases at least two prepreg material layers, and/or not more than 15 prepreg material layers, preferably not more than 11 prepreg material layers, particularly preferably not more than four prepreg material layers.

### BRIEF DESCRIPTION OF THE SEVERAL VIEWS OF THE DRAWINGS

Further features and advantages of the present disclosure emerge from the following description, in which preferred embodiments of the disclosure are explained by way of example with reference to schematic drawings. In the drawings:

FIG. 1 shows a perspective illustration of a mop system according to the present disclosure;

FIG. 2 shows a sectional view of the mop system according to FIG. 1;

FIG. 3a shows a detailed view of a locking device in a stop position;

FIG. 3b shows a sectional view of the locking device according to FIG. 3a corresponding to the section line B-B;

FIG. 3c shows a sectional view of the locking device according to FIG. 3b corresponding to the section line C-C;

FIG. 3d shows a sectional view of the locking device according to FIG. 3b corresponding to the section line D-D;

FIG. 3e shows a schematic side view of the locking device corresponding to FIG. 3d;

FIG. 4a shows a schematic view of a locking device according to at least one embodiment with handle sections of different cross-sections;

FIG. 4b shows a schematic cross-sectional view through the outer handle section at the inner end of the inner handle section;

FIG. 4c shows a further schematic cross-sectional view through the mop handle corresponding to the section line D-D;

FIG. 5 shows a special embodiment of a mop holder;

FIG. 6 shows a sectional view of a first actuating part of an alternative locking device in a stop position:

FIG. 7 shows another sectional view of the alternative locking device according to FIG. 6;

FIG. 8 shows a sectional view of a second actuating part of the alternative locking device;

FIG. 9 shows a detailed view of a holding member for a locking device; and

FIG. 10 shows a further detailed view of the holding member according to FIG. 9.

In the following description of preferred embodiments, the same or similar reference signs are used to simplify readability for the same or similar components.

### DETAILED DESCRIPTION

A mop handle generally has the reference sign 1. A mop holder generally has the reference sign 2. A connecting part generally has the reference sign 8. A mop system generally has the reference sign 10. Flat mop holder 2, connecting piece 8, mop handle 1 and/or mop cover 11 can belong to a kit of parts from which a mop system 10 can be formed.

In the exemplary embodiment illustrated in the figures, it is provided that at least some of the components of a mop system 10 comprise or consist of an aramid fiber-reinforced and/or carbon fiber-reinforced plastic. In this way, considerable weight savings can be achieved, so that the cleaning personnel is assisted in a continuous use of the mop system 10, in some cases when cleaning wall surfaces and/or ceiling surfaces, for example of a clean room. In the following description of exemplary embodiments, for the sake of ease of readability, a particularly preferred embodiment is described, according to which the components optionally consist of carbon fiber-reinforced plastic.

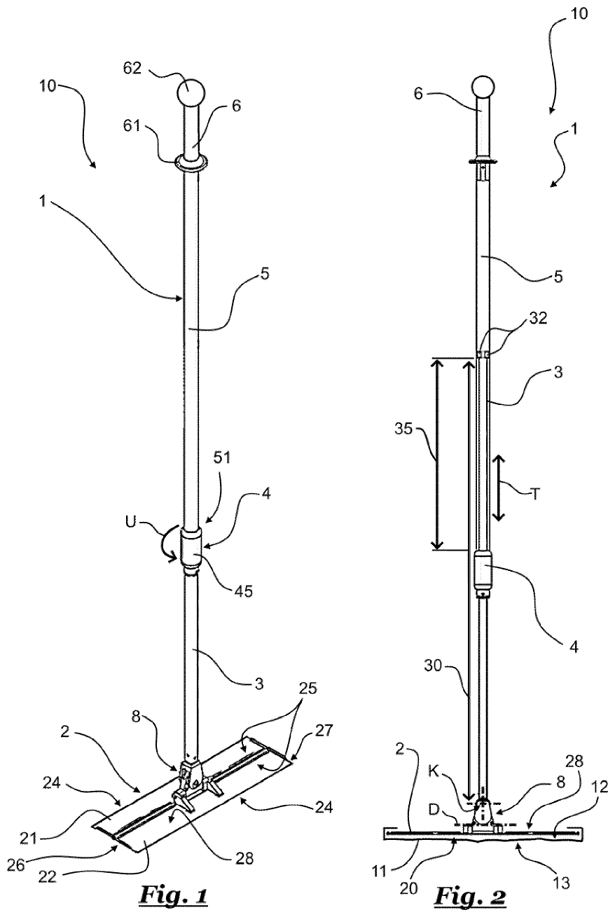

FIG. 1 shows a perspective illustration of a mop system 10. The mop system 10 comprises as essential components a mop handle 1 and a mop holder 2. As illustrated in FIG. 2, the mop holder 2 can carry a mop cover 11.

FIG. 2 shows a mop system 10. A flat mop holder 2 is provided at the lower end of the mop system 10. The flat mop holder 2 is movably articulated to the mop handle 1 by a connecting piece 8.

The mop holder 2 can have a release device for the mop cover 11, wherein the release device can comprise, for example, two mop holding wings 21, 22 pivotable relative to one another, as illustrated in FIG. 1. The mop holding wings 21 and 22 can be foldable relative to one another, for example, along their adjacent rear edges 25. The mop holder 2 can have a flat-rectangular shape which is defined by mutually opposite side edges 26, 27 and mutually opposite front edges 24 of the two mop holding wings 21 and 22. The mop holding wings 21 and 22 together form a flat surface for wiping a flat wall, ceiling or floor surface. The inner side 12 of the mop cover 11 can bear against the common lower side 20 of the mop holding wings 21 and 21, as illustrated schematically in FIG. 2. Opposite the inner side 12, the mop cover 11 has an outer or active side 13 which is brought into contact with a surface to be treated operationally. The connecting piece 8 is arranged on the upper side 28 of the mop holder 2, which faces the mop handle 1.

In the illustrated embodiment, the first mop holding wing 21 and the second mop holding wing 22 consist of carbon fiber-reinforced plastic. Reinforcing ribs 29 consisting of carbon fiber-reinforced plastic can be formed on the upper side 28 of the mop holder 2. The joints on the rear edges 25 of the mop holding wings 21, 22 can comprise or consist of another material, such as stainless steel and/or POM.

The connecting piece 8, by way of which the mop holder 2 is connected to the mop handle 1, preferably comprises a rotational-tilt joint which permits a tilting inclination of the mop handle 1 relative to the mop holder 2 about a tilt axis K and a rotational inclination of the mop handle 1 relative to the mop holder about an axis of rotation D. The axis of rotation D and the tilt axis K are oriented transversely, preferably orthogonally, to one another. The connecting piece 8 comprises carbon fiber-reinforced plastic as structural material which mechanically supports the joint pairings. The joint pairings can comprise or consist of another material, such as stainless steel and/or a plastic material, in some cases selected from a group consisting of thermosets, preferably epoxy resins, thermoplastics and mixtures thereof, for example POM.

The mop handle 1 is connected or connectable to the connecting piece 8 at its lower end. The mop handle 1 comprises a lower mop handle section 3 and an upper mop handle section 4 which are movable telescopically relative to one another in the longitudinal direction T. In the illustrated embodiment, the lower mop handle section 3 is formed as an inner mop handle section which has a smaller diameter than the upper, outer mop handle section 4. The outer mop handle section 5 receives a part of the inner mop handle section 3 in an inner cavity. The length 35 of the inner mop handle section 3 which can be received in the outer mop handle section 5 can correspond virtually to the total length 30 of the inner mop handle section 3.

A handle 6 can be provided at the upper end of the mop handle 1. The handle 6 can comprise or be formed from another material than carbon fiber-reinforced plastic, for example stainless steel and/or POM. The handle 6 can comprise an anti-slip protection, for example in the form of a shield 61. The shield 61 can comprise carbon fiber-reinforced plastic. Alternatively or additionally, the handle 6 can have, for example, a spherical knob 62 in order to facilitate working on wall or ceiling surfaces.

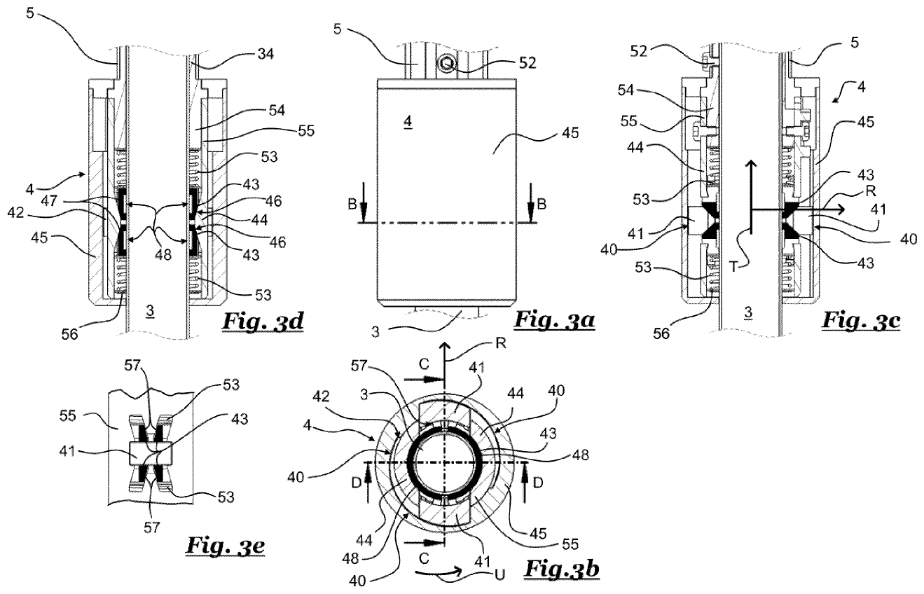

A locking device 4, which is described in more detail below with reference to FIGS. 3 a to 3 d, is fastened to the mop holder-side end 51 of the upper mop handle section 5. The locking device 4 generally serves to hold the inner mop handle section 3 in a fixed position relative to the outer mop handle section 5. The locking device 4 can comprise carbon fiber-reinforced plastic and also other materials, for example stainless steel and/or a plastic material, in some cases selected from a group consisting of thermosets, preferably epoxy resins, thermoplastics and mixtures thereof, for example POM. For example, the structural components of the locking device can consist of POM or comprise POM, whereas screws and/or spring components of the locking device 4 comprise or can consist of steel, for example.

In the illustrated embodiment, the tubular mop handle sections 3 and 5 consist of carbon fiber-reinforced plastic. In the preferred embodiment illustrated here, the mop handle sections 3 and 4 have a hollow-cylindrical shape having a circular cross-section. An embodiment with an inner, lower mop handle section 3 and an outer, upper mop handle section 5 is illustrated. It should be clear that, as an alternative to the illustrated embodiment, the outer mop handle section 5 can be adapted as a lower mop holder-side section and the inner mop handle section 3 can be adapted as an upper mop holder-far section. In this alternative embodiment (not illustrated), the locking device 4 would expediently be arranged at the mop holder-far end of the outer mop handle section.

Sliding pieces 32, 34, for example sliding rings, which can be formed from another material than carbon fiber-reinforced plastic, in some cases a plastic material selected from a group consisting of thermosets, preferably epoxy resins, thermoplastics and mixtures thereof, for example POM, can be arranged in the radial direction R between the inner mop handle section 3 and the outer mop handle section. A sliding piece 32 at the mop holder-far end of the inner mop handle section 3, which is located in the interior of the outer mop handle section 5, can be seen in FIG. 2. The support section 54, described in more detail below, at the lower end 51 of the upper mop handle section 5 forms a further sliding piece 34. The sliding pieces 32, 34 allow a low-friction and wedging-free translational telescopic movability of the inner mop handle section 3 relative to the outer mop handle section 5 in the longitudinal direction T.

FIGS. 3a to 3d show various detailed views of the locking device 4. With the locking device 4, a force-fitted, positional fixed connection can be optionally opened or closed by the cleaning personnel. In a holding position, the locking device 4 forms the force-fitted, positional fixed connection between the inner mop handle 3 and the outer mop handle 5 with the aid of a plurality of holding members 43. In the release position of the locking device 4, the force-fitted, positional fixed connection between the inner mop handle section 3 and the outer mop handle section 5 is released so that the mop handle sections 3, 5 are telescopic relative to one another.

In order to control the locking device 4, the locking device 4 has an actuating part 45 which, in the exemplary embodiment illustrated here, is formed as a cylindrical sleeve 45. The sleeve 45 can be moved relative to the longitudinal axis of the mop handle 1 in the circumferential direction U between a start position and a stop position shown in FIGS. 3a to 3d. In the stop position of the actuating part 45, the holding member 43 is located in the holding position. In the start position of the actuating part 45, the holding member 43 is in the release position.

The support section 54 is fastened stationary to the outer mop handle section 5 with a fastening mechanism 52. The fastening mechanism 52 can be guided in the radial direction R through the wall of the outer mop handle section 5 up to the inner mop handle section 3 through the wall of the inner mop handle section 3, in order to prevent a rotational mobility of the inner mop handle section R in the circumferential direction U with respect to the outer mop handle section 5. The actuating sleeve 45 is rotatably mounted on the support section 54.

A multi-purpose sleeve 55 is rigidly fastened to the support section 54. The multi-purpose sleeve 55 acts, inter alia, as a counter-stop 44. The counter-stop 44 is described in detail below. The multi-purpose sleeve 55 receives two sliding wedges 41 diametrically opposite each other in the radial direction in a radially movable manner. The multi-purpose sleeve 55 forms a respective guide for the sliding wedges 41, which prevents a movability of the sliding wedges 41 relative to the outer mop handle section 5 in the circumferential direction U and also in the longitudinal direction T. In the guide of the multi-purpose sleeve 55, the sliding wedge 41 is movable only in the radial direction R.

Radially on the inside, the sliding wedge 41 is located in touch contact with two pairs of holding members 43 each. Radially on the outside, the sliding wedge 41 is mounted on an eccentric sliding surface 40 of the actuating part 45. When the actuating part 45 is rotated in the circumferential direction U, the sliding surface 40 moves along the radially outer side surface of the sliding wedge 41. The radially outer side surface of the sliding wedge 41 and the sliding surface 40 of the actuating part 45 are adapted in shape to each other. Due to the eccentricity of the sliding surface 40, when the actuating sleeve 45 is rotated relative to the mop handle 1, the sliding wedge 41 is caused to move in the radial direction R towards the mop handle 1 or away from the mop handle 1. The sliding wedge 41 and the actuating sleeve 45 are matched to one another such that in the stop position of the actuating sleeve 45, the sliding wedge 41 adopts its radially outermost position. In the start position of the actuating sleeve 45, the sliding wedge 41 is located in its radially innermost position.

The multi-purpose sleeve 55 serves as a counter-stop 44 for the holding members 43. In the illustrated embodiment, the locking device 4 has four annular section-shaped holding members 43. The holding members 43 extend in the circumferential direction partially circumferentially around the outer side of the inner mop handle section 3, as can be seen in FIG. 3b. In the longitudinal direction T, in each case two holding members 43 are arranged adjacent to one another, which are held on different wedge or stop surfaces 46 of the counter-stop 44. The upper wedge surface 46 tapers conically downwards and the lower wedge surface 46 tapers conically upwards. The radial outer side of the holding members 43 is shaped at least in sections adapted in shape to the conical wedge surface 46. In the radial direction R, in each case two holding members 43 lie diametrically opposite one another in pairs.

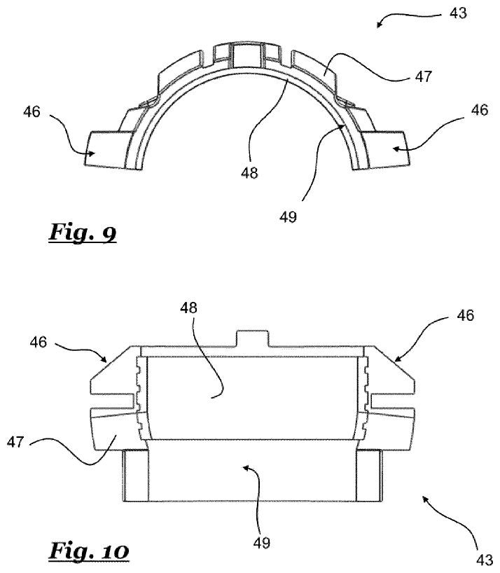

The locking device 4 comprises two compression springs 53 opposite each other in the longitudinal direction T as pretensioning mechanism. The upper compression spring 53 is supported on the support section 54 in the longitudinal direction T and brings about a pretensioning force directed downwards corresponding to the longitudinal direction T on the upper pair of holding members 43. A plate-like second support section 56 is provided at the lower end of the multi-purpose sleeve 55, on which the lower compression spring 53 is supported in the longitudinal direction T. The lower compression spring 53 brings about a pretensioning force directed upwards corresponding to the longitudinal direction on the lower pair of holding members 43. The compression springs 53 force the holding members 43 respectively assigned to them in the longitudinal direction T against the respective wedge surface 46. The spring force acting in the longitudinal direction on the holding members 43 forces the holding members 43 along the wedge surface 46 inwards in the radial direction R against the inner mop handle section 3. In the holding position, the holding members 43 are forced against the inner mop handle section 3 such that a force-fitted connection is realized between the outer mop handle section 5 and the inner mop handle section 3. The force-fitted connection advantageously realizes a gripping coating 48 arranged on the respective inner surface 49 of the holding members 43, as is described in detail below with reference to FIGS. 9 and 10. The gripping coating 48 forms an adhesive pairing with the outer side of the inner mop handle section 3 with a high coefficient of static friction. The gripping coating 48 is preferably made of an elastic material. For example, the gripping coating 48 comprises or consists of a TPE material, in some cases a TPU or TPV material, preferably TPU material.

To release the force-fitted connection, the sliding wedge 41 in the start position of the actuating part 45 forces between the adjacent holding members 43 in the longitudinal direction T and forces them apart in the longitudinal direction T against the force of the compression spring 53. Due to the fact that the sliding wedge 41 forces the holding members 43 out of the holding position in the longitudinal direction T, the holding members 43 reach a release position remote from the mop handle 3 in the radial direction R. When the holding members 43 are forced away from the mop handle section 3 by the sliding wedge 51, the force-fitted connection is released and the inner mop handle section 3 is freely telescopically movable in the longitudinal direction T relative to the outer mop handle section 5 (not illustrated in more detail).

FIG. 3e shows a schematic side view of the multifunctional sleeve 55 of the locking device 4 with a viewing angle corresponding to the view of FIG. 3d. The multifunctional sleeve 55 comprises second wedge surfaces 57 which cooperate with the holding members 43. When the holding members 43 are released from the holding position by the sliding wedge 41, the second wedge surface 57 bring about that the holding members 43 are additionally imparted a movement away from one another in the radial direction R during their movement in the longitudinal direction. The second wedge surfaces 57 ensure that the sliding wedge 41 moves the holding members 43 away from the inner mop handle section 3 in the radial direction R.

The outer circumference of the multifunctional sleeve 55 is preferably ideally cylindrical and coaxial to the mop handle 1. The actuating member 41 expediently has an adjusting section 42 with an ideally cylindrical inner circumference formed coaxially to the mop handle 1. The adjusting section 42 slides along the outer circumference of the multifunctional sleeve 55.

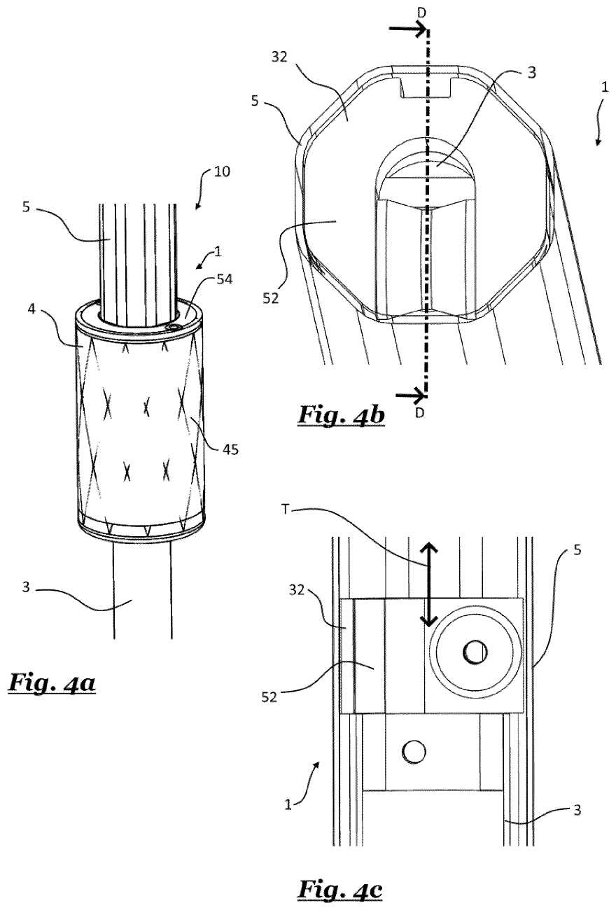

FIG. 4a shows a schematic view of a mop system 10 close to its locking device 4, wherein the mop system 10 comprises the handle sections 3 and 5 of different cross-sectional shapes. In the illustrated embodiment, the outer, upper handle section 5 has an octagonal cross-sectional shape. The inner, lower handle section 4 expediently has a circular cross-sectional shape.

FIGS. 4b and 4c show schematic cross-sectional views through the outer handle section 5 at the inner end of the inner handle section 3. At the end of the inner handle section 3 arranged in the interior of the outer handle section 5, a sliding piece 32 is connected to the inner handle section 3 in a rotationally rigid manner as an anti-twist protection. The sliding piece 32 is adapted in sections in a shape-complementary manner to the rotationally asymmetric octagonal cross-sectional shape of the outer handle section 5 and thus realizes a fastening mechanism 52 in functional union. The inner handle section 3 is guided in the interior of the outer handle section 5 in a translationally movable and rotationally rigid manner by way of the sliding piece 32.

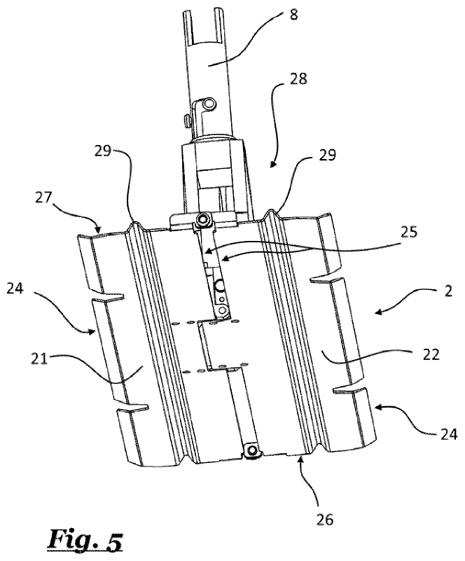

The mop holding wings 21, 22 can have centrally in the transverse direction one or more longitudinal ribs 29 which extend in the direction of the upper side 28 of the flat mop holder 2. Additionally or alternatively, a mop holding wing 21, 22 can have substantially planar flat sections, preferably substantially coplanar with respect to one another. The longitudinal rib 29 preferably extends from a flat section in the direction of the upper side 28. As can be seen in FIG. 5, the longitudinal rib 28 can be formed as a curvature of the mop holding wing 21, 22 which protrudes convexly in the vertical direction V and which extends parallel to the pivot axis or longitudinal direction L, respectively.

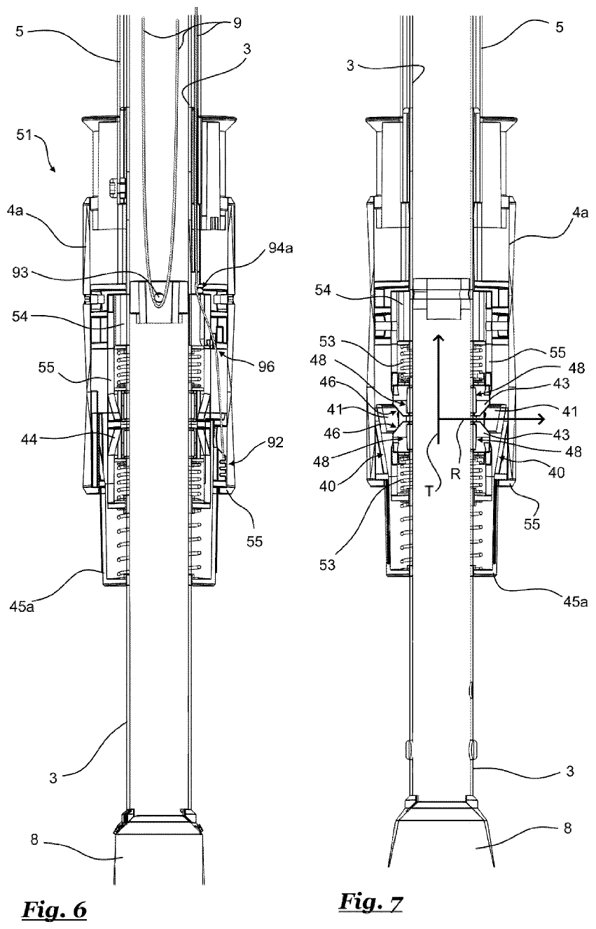

FIGS. 6 to 8 show an alternative, two-part locking device 4 a, 4 b which can be used instead of the locking device described above with respect to FIGS. 3 a to 3 e. For the function of the locking device 4a, 4b, with the exception of the actuating direction of the actuating members 4a, 4b and the coupling thereof to a cable pull 9 as force transmission mechanism, substantially the above applies. A sliding piece 32 is fastened to the upper end of the inner mop handle 3, with which the inner mop handle 3 is guided in the outer mop handle 5. Additionally or alternatively, two diametrically opposite guide rollers 33 are arranged at the upper end of the inner mop handle 3, with which the inner mop handle 3 rolls on the inside on the outer mop handle 5. In the illustrated embodiment, the outer mop handle 5 has an octagonal cross-sectional shape and the inner mop handle 3 has a circular cross-sectional shape.

A support section 54 is rigidly fastened to the lower end of the upper, outer mop handle 5. An actuating sleeve 45 a is movably mounted on the support section 54 in the translational direction T. The actuating sleeve 45 a is arranged at the lower end of the locking device 4a. The locking device 45a is forced by a spring into the position illustrated in the figures. The position can be referred to as the stop position because in this position the holding members 43 are in contact engagement with the inner mop handle 3.

The holding members 43 are forced by pretensioning mechanism 53 against oblique wedge surfaces 46, wherein the oblique wedge surfaces 46 force the holding members 43 in the radial direction R against the inner mop handle 3. The wedge surfaces 46 are formed on the sliding wedge 41, which is arranged in the translational direction T between the holding members 43 and is supported in the radial direction on the outside on a conical sliding surface 40. The sliding surface 40 is connected to the actuating sleeve 45a.

The actuating sleeve 45a of the first locking device 4a can be displaced in the translational direction T against the force of the spring. The sliding surface 40 is firmly connected to the actuating sleeve 45a and performs the same movement as the actuating sleeve 45a. When the conical sliding surface 40 moves upwards in the translational direction T, the sliding surface 40 forces the sliding wedge 41 inwards in the radial direction R. The holding members 43 then slide along the wedge surfaces 46 of the sliding wedge 41 in the translational direction T against their pretensioning mechanism 53 and thereby release the inner mop handle 3.

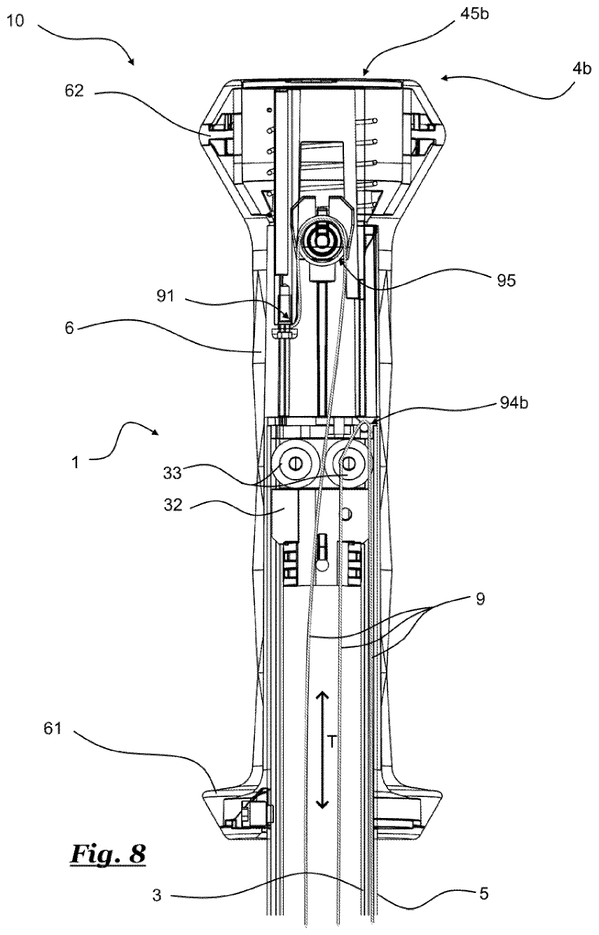

An optional second locking device 4b is illustrated in FIG. 8. An actuating button 45b is accommodated in the knob 62 of the handle 6. By way of a translational movement of the actuating button 45b, the holding member 43, which can be realized as described below with reference to FIGS. 9 and 10, can be displaced between the holding position and the release position. The second locking device 4b is adapted and arranged to cause the first locking device 4b to displace the holding member 43 between the holding position and the release position. A spring pretensions the actuating button 45b in the direction of the holding position. A cable pull 9 serves as a force transmission mechanism between the second locking device 4b and the first locking device 4a.

The cable pull 9 has a first end which is expediently held firmly on the actuating sleeve 45a by way of a first anchoring 91. A second anchoring 92 fixes the second end of the cable pull 9 on the actuating button 45b. When the actuating button 45b is activated, the activation movement is transmitted via the cable pull 9 to the actuating sleeve 45a. According to an alternative embodiment (not illustrated in more detail), the second actuating part 4b can act directly on the holding member without a first actuating part with the force transmission mechanism.

From the second anchoring 92, the cable pull 9 initially runs over a deflection pulley 95 rotatably mounted stationary on the upper end of the outer mop handle 5. From the deflection pulley 95, the pulling cable of the cable pull 9 extends into the inner mop handle 3 and runs around a deflection mechanism 93 held stationary on the lower end of the inner mop handle 3.

From the lower deflection mechanism 93, the pulling cable 9 runs to an insertion deflection mechanism 94b at the upper end of the inner mop handle 3. The insertion deflection mechanism 94b is adapted and arranged to guide the pulling cable securely into the circumferential gap between the outer mop handle 5 and the inner mop handle 3. The pulling cable 9 runs from the upper insertion deflection mechanism 94b to a lower insertion deflection mechanism 94a at the lower end of the outer mop handle 5. The lower insertion deflection mechanism 94a is likewise adapted and arranged to guide the pulling cable securely into the circumferential gap between the outer mop handle 5 and the inner mop handle 3.

From the lower insertion deflection mechanism 94a, the pulling cable runs over a deflection mechanism 96 held firmly on the support section 54 to the first anchoring 91. When the actuating button 45b is pressed, it receives the second end of the cable pull 9 via the second anchoring 92. The cable movement is transmitted by the cable pull 9 and moves the first anchoring 91 of the actuating sleeve 45a in a translational direction T.

Thanks to the S-shaped guidance of the pulling cable along the insertion deflection mechanism 94a, 94b and around the lower deflection mechanism 93, the cable pull can be used as a length-adjustable force transmission mechanism in any telescopic position of the mop system 10.

FIGS. 9 and 10 show a detailed view of an exemplary holding member 43. The holding member 43 has a gripping coating 48 on its inner surface 49 facing the inner mop handle section 3. In the illustrated embodiment, the holding member 43 is composed of a support body 47 and a gripping coating 48.

In this embodiment, the support body 47 is dimensionally stable and the gripping coating 48 is elastic. In some cases, the gripping coating comprises or consists of an elastomer material, in some cases a thermoplastic elastomer, preferably a TPU (thermoplastic elastomer) and/or TPV (thermoplastic vulcanizate) material. In the illustrated embodiment, the support body 47 and the gripping coating 48 of the two holding members attached thereto each extend approximately 1700 in the circumferential direction and are preferably designed in the shape of a partial ring, in some cases essentially in the shape of a half ring.

The support body 47 preferably comprises or consists of a thermosetting plastic or a thermoplastic, such as PEEK, PEI, POM and/or PPSU. The gripping coating 48 is fastened to the support body 47. For example, the holding member can be manufactured as a two- or more-component injection molded part. The support body 47 is preferably matched to the pretensioning mechanism 53 and can thus be in touch contact. The support body 47 forms the wedge surface 46 which is adapted to cooperate with the second wedge surface 57 and the sliding wedge 41.

The features of the present disclosure disclosed in the preceding description, in the claims and in the drawings can be essential both individually and in any combination for the realization of the disclosure in its various embodiments.

### REFERENCE SIGNS

1 Mop handle
2 Mop holder
3 inner mop handle section
4, 4a, 4b locking device
5 outer mop handle section
6 handle
8 connecting piece
9 cable pull
10 mop system
11 mop cover
12 inner side
13 outer side
20 lower side
21, 22 mop holding wings
24 front edge
25 rear edge
26, 27 side edge
28 upper side
29 reinforcing ribs
30 total length
32, 34 sliding piece
33 guide roller
35 length received
40 sliding surface
41 sliding wedge
43 holding member
44 counter-stop
45, 45 actuating sleeve
45b actuating button
46 wedge surface
47 support body
48 gripping coating
49 inner surface
51 mop holder-side end
52 fastening mechanism
53 pretensioning mechanism
54 support section
55 multi-purpose sleeve
56 support section
57 second wedge surface
61 shield
62 knob
91, 92 anchoring
93, 96 deflection mechanism
94a, 94b insertion deflection mechanism
95 deflection pulley
D axis of rotation
K tilt axis
R Radial direction
T longitudinal direction
U circumferential direction

The various embodiments described above can be combined to provide further embodiments. All of the patents, patent application publications, and non-patent publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A mop holder for a mop system for cleaning clean rooms, arranged and adapted to releasably hold a mop cover, wherein the mop holder comprises an aramid fiber-reinforced and/or carbon fiber-reinforced plastic.

2. The mop holder according to claim 1, wherein the mop holder has a rectangular basic shape, wherein the mop holder has a length in the range of 35 to 55 cm, and a width in the range of 8 to 20 cm.

3. The mop holder according to claim 1, wherein the mop holder comprises at least one holding wing, wherein the at least one holding wing has a longitudinal rib which is curved towards an upper side of the mop holder, and wherein the longitudinal rib extends from a flat section to the upper side.

4. A mop system for cleaning clean rooms, comprising a mop holder according to claim 1 and a mop handle.

5. The mop system according to claim 4, wherein the mop system is heat-resistant to 140° C. and/or resistant to cleaning and/or disinfecting agents.

6. The mop system according to claim 4, wherein the mop handle comprises at least one tubular mop handle section comprising an aramid fiber-reinforced and/or carbon fiber-reinforced plastic.

7. The mop system according to claim 4, wherein the aramid fiber-reinforced and/or carbon fiber-reinforced plastic of the mop handle and/or of the at least one tubular mop handle section comprises plastic material selected from a group consisting of thermosets, epoxy resins, thermoplastics, and mixtures thereof.

8. The mop system according to claim 6, wherein the at least one tubular mop handle section has a rounded cross-sectional shape.

9. The mop system according to claim 4, the mop handle comprising a plurality of mop handle sections that are movable telescopically relative to one another.

10. The mop system according to claim 9, the plurality of mop handle sections comprising at least one inner mop handle section and at least one outer mop handle section which receives the at least one inner mop handle section at least in sections.

11. The mop system according to claim 10, wherein the at least one inner mop handle section has a different cross-sectional shape than the at least one outer mop handle section.

12. The mop system according to claim 9, further comprising a locking device which has at least one holding member which is movable transversely to the plurality of mop handle sections and which, in a holding position, holds at least one mop handle section in a longitudinal direction in a fixed position relative to at least one other mop handle section and which, in a release position, permits a translational movement of the at least one mop handle section relative to the at least one other mop handle section in the longitudinal direction.

13. The mop system according to claim 12, wherein the locking device comprises at least one support section fastened to an outer mop handle section in a longitudinal direction, on which at least one pretensioning mechanism is supported which forces the at least one holding member against an inner mop handle section, and/or on which at least one counter-stop is fastened, which has at least in sections an inclined wedge surface on which the at least one holding member is guided in a radial direction and/or the longitudinal direction.

14. The mop system according to claim 13, wherein the locking device comprises at least one actuating part movable relative to the outer mop handle section, which is adapted and arranged to displace the at least one holding member between the holding position and the release position.

15. The mop system according to claim 13, wherein the locking device comprises a sliding wedge which is held stationary relative to the outer mop handle section in a circumferential direction and movable in the radial direction and which is guided on an inner contour of the at least one actuating part such that in a first relative position of the at least one actuating part to the sliding wedge, the sliding wedge forces the at least one holding member, against the pretensioning mechanism into the release position, and that in a second relative position of the at least one actuating part to the sliding wedge, the pretensioning mechanism brings the at least one holding member into the holding position, wherein the pretensioning mechanism presses the sliding wedge against the inner contour.

16. The mop system according to claim 12, wherein the at least one holding member has at least one gripping coating which is arranged on an inner surface facing the at least one mop handle section, wherein the at least one holding member has a support body to which the at least one gripping coating is fastened and/or which cooperates with the sliding wedge and/or the pretensioning mechanism.

17. A mop handle for a mop system for cleaning clean rooms, comprising:
at least one inner mop handle section,
at least one outer mop handle section which receives the at least one inner mop handle section at least in sections, and
a locking device which has at least one holding member which is movable transversely to the inner and outer mop handle sections and which, in a holding position, holds at least one of the inner or outer mop handle section in the longitudinal direction in a fixed position relative to at least one other of the inner or outer mop handle section and which, in a release position, permits a translational movement of the at least one mop handle section relative to the at least one other mop handle section in a longitudinal direction.

18. The mop handle according to claim 17, wherein the at least one holding member has at least one gripping coating, which is arranged on an inner surface facing the at least one mop handle section, wherein the holding member has a support body to which the gripping coating is fastened and/or which cooperates with a sliding wedge and/or a pretensioning mechanism.

19. (canceled)

20. A kit of parts, comprising a mop holder according to claim 1, and further comprising a flat mop cover.
